(19) United States
(12) Patent Application Publication
(10) Pub. No.: US 2026/0283083 A1
(43) Pub. Date: Sep. 24, 2026

(54) TYING SYSTEM FOR ESPALIER MACHINES AND RELATED TYING MACHINE

(71) Applicant: OLMI S.R.L., COSTIGLIOLE D'ASTI (AT) (IT)

(72) Inventor: Franco OLMI, COSTIGLIOLE D'ASTI (AT) (IT)

(21) Appl. No.: 19/475,394

(22) PCT Filed: Apr. 16, 2024
(86) PCT No.: PCT/IB2024/053696

§ 371 Date: Oct. 14, 2025

(30) Foreign Application Priority Data
Apr. 18, 2023 (IT) 102023000007476

(51) Int. Cl. A01G 17/08

(52) U.S. Cl. CPC A01G 17/085

(57) ABSTRACT

A tying system includes a support structure for connecting to an espalier machine. A first arm assumes first and second configurations. A second arm interacts with the first arm in the second configuration. An actuator moves the first arm between the first and second configurations. The first arm includes a first guide member at a distal end of the first arm. The first guide member guides a first cord. The second arm includes a tying device at a distal end of the second arm. The tying device has a second guide member guiding a second cord. The tying system arranges the first and second cords side-by-side in the second configuration. The tying system has a feeder moving wire from a first reel, a cutting device to cut the wire, and a forming device to bend the wire, trapping the cords side-by-side before the cutting device cuts the bent wire.

The present invention relates to a tying system adapted for application to espalier machines, in particular for fruit plants such as vines.

A further aspect of the present invention relates to an espalier machine or green tying machine.

The espalier machine or green tying machine is adapted to arrange a row of plants, e.g. vines, on an espalier structure by progressively raising the branches or shoots and by securing them against suitable supports, thus being particularly useful for tying summer vine shoots. In late spring, in fact, vineyard vegetation sprouts vigorously and shoots become considerably longer, so that such shoots need to be tied to support wires.

When carried out manually, this task is very costly because it requires many hours of labour. As is known to those skilled in the art of vine growing, this process must be executed at the right time, since shoots must be long enough to be tied correctly, without however being too long and hence subject to damage. During this vegetative phase of the vine plant, in fact, vine shoots are very delicate and must be handled with care to avoid breaking them.

Moreover, this task must be carried out at least twice during the production season. It is therefore clear that there is a need for a timely and quick intervention.

For the purposes of the present description, the term “espalier machine” also refers to a green tying machine. In the description that follows, the term “espalier machine” will solely be used.

Espalier machines normally comprise a portal-shaped frame applied to the front of a tractor and driven by hydraulic cylinders for making the necessary adjustments over row of plants. In the currently known espalier machines, the front connection implies the need for adapting them to different tractor models, in addition to placing a (substantial) load onto a portion of the tractor that, in many cases, has not been designed to withstand heavy loads. Last but not least, the front connection of espalier machines results in a load distribution that may reduce the stability of the assembly consisting of tractor and espalier machine, particularly when working in hilly environments or on sloping ground.

On both sides of the portal there are raising devices adapted to raise the branches or shoots that have grown away from the row, sometimes even touching the ground, for subsequently tying them. Two types of raising devices are currently known in the art: a first type uses two screws to collect branches or shoots, which screws are however aggressive towards the vegetation, bulky and heavy; a second type uses sliding belts with protrusions for collecting the vegetation, this type being less aggressive towards the vegetation, smaller and lighter.

The frame comprises also a tying system that comprises two mobile arms, arranged at the base of the machine and adapted to guide respective cords, e.g. made of fabric, nylon and/or hemp, wherein said cords are adapted to support the branches or shoots. Said arms are so connected that they can be opened away from each other and closed towards each other. When the arms are close to each other, the tying device is activated in order to tie the two cords as the machine moves along. Such cords are then laid further along by the espalier machine as it moves along the row of plants.

Espalier machines are known which comprise a tying system using pre-formed clips, normally made of plastic material, which must be housed into a suitable loader or magazine arranged on an arm of the tying system. Such a type of machine is described, for example, in the following patent documents EP0318406B1, DE20304800U1, EP4032397A1 and DE102007019187B3.

All espalier machines described in such patent documents make use of staples or clips, made of metal or plastic material, in order to mutually tie the supporting cords. Therefore, this implies a considerable economical disadvantage for the user, because it is necessary to purchase specific consumable items, particularly specific staples or clips for each espalier machine, and it is periodically necessary to refill the tying system with such clips when the magazine or loader of such tying systems is empty.

The use of a loader or magazine results in the tying system being very heavy, and the additional mass is located at a distal end of said arms of the system, implying the need for increasing the total weight of the tying system and hence the weight of the espalier machine as a whole.

The problem of the weight of the espalier machine is particularly felt when vineyards in hilly regions are involved, where lighter, more compact machines are needed which can be handled and controlled safely by the operator even on steep ground.

Espalier machines are also known which utilize a rigid wire, e.g. metal wire, which is suitably cut to size. The cut-to-size wire is then bent by the tying system in order to trap and retain said cords.

Such machine types suffer from the drawback that both arms of the tying system are fitted with elements that are essential in order to give the cut-to-size wire the appropriate shape. In particular, one arm acts as a hammer, while the other arm acts as an anvil, so that both arms must have a structure capable of taking the blows necessary for shaping the cut-to-size wire section as a clip or staple. Such a machine is described, for example, in the following patent documents EP0897661B1 and IT1030384B.

Such a type of espalier machine is, therefore, affected by weight-related problems, thus being hardly usable on vineyards in hilly areas.

Lastly, an apparatus is known from patent application U.S. Pat. No. 5,682,927 which comprises tying material feeding means, tying material bending means, encompassing and guiding means, tying material cutting means and twisting means, wherein a starting point is formed in a way such that a part of a continuous linear tying material delivered from the tying material feeding means comes into engagement with the tying material bending means so that the tying material is bonded into a U-shape. In that state, the tying material is delivered from one side whereby the tying material is guided around an article to be tied by the encompassing and guiding means while being bent into a substantially U-shape. The tying material is cut to a predetermined length, and both ends of the tying material are twisted together by a hook of the twisting means.

The present invention aims at solving the problems suffered by the prior art by proposing an innovative, reliable and easy-to-implement solution that reduces the overall weight of the tying system and hence of the espalier machine as a whole, thus making the latter usable anywhere, even on steep ground.

The solution according to the present invention makes it possible to easily and quickly tie both cords, without requiring the use of any staples or clips fed from loaders or magazines arranged on an arm H the tying system.

One aspect of the present invention relates to a tying system having the features set out in the appended claim 1.

A further aspect of the present invention relates to an espalier machine having the features set out in the appended claim 10.

The features and advantages of the system and machine will become clear and apparent in light of the following description of several possible embodiments thereof, provided herein by way of non-limiting example, as well as from the annexed drawings, wherein:

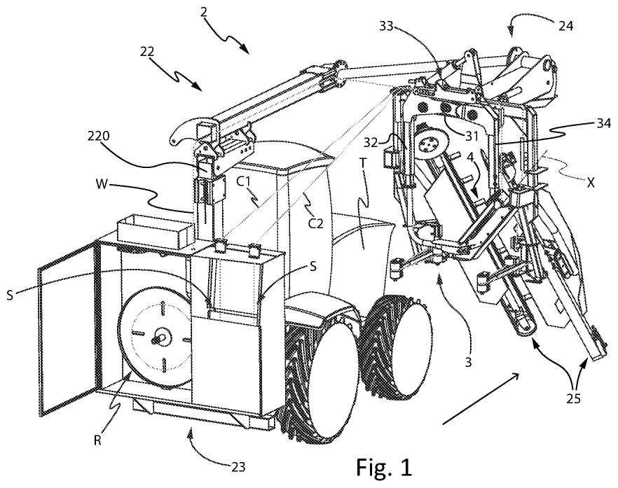

FIG. 1 shows an axonometric rear view of an espalier machine applied to a tractor;

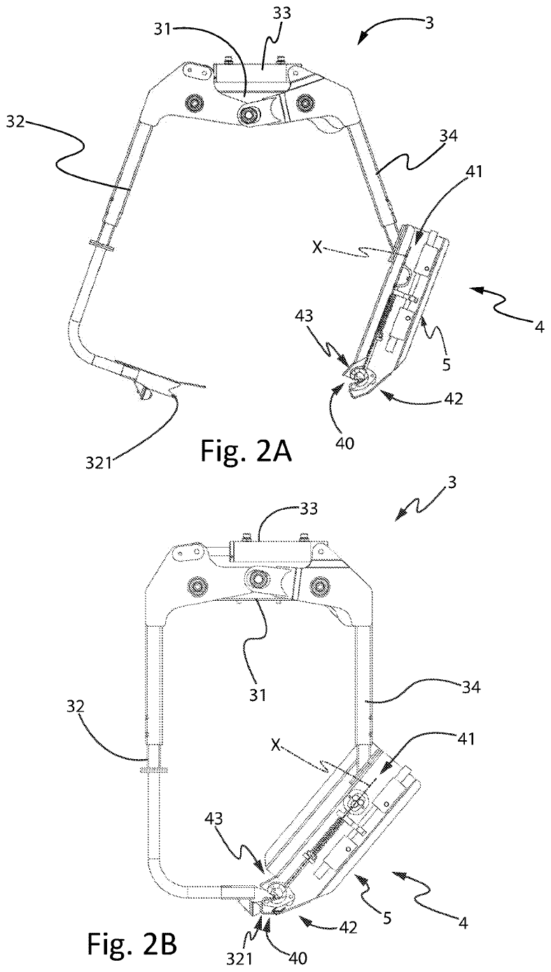

FIGS. 2A and 2B show the tying system in its two different operating configurations: FIG. 2A shows the tying system in a first configuration, or open configuration; FIG. 2B shows the tying system in a second configuration, or closed configuration;

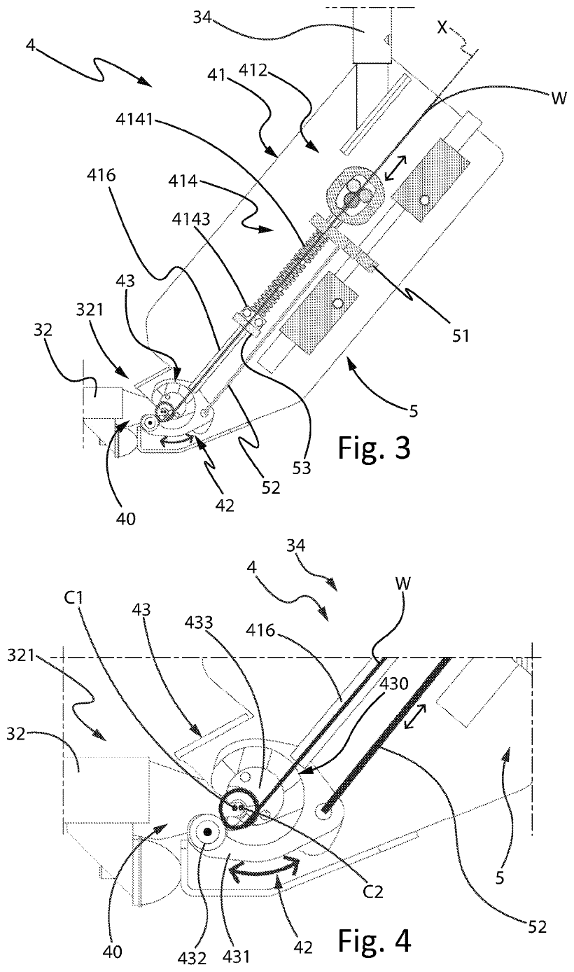

FIG. 3 show a tying device applied to an arm in the second configuration of the tying system, wherein the wire has been bent, but not yet cut;

FIG. 4 shows a detail of the forming device and cutting device comprised in the tying device;

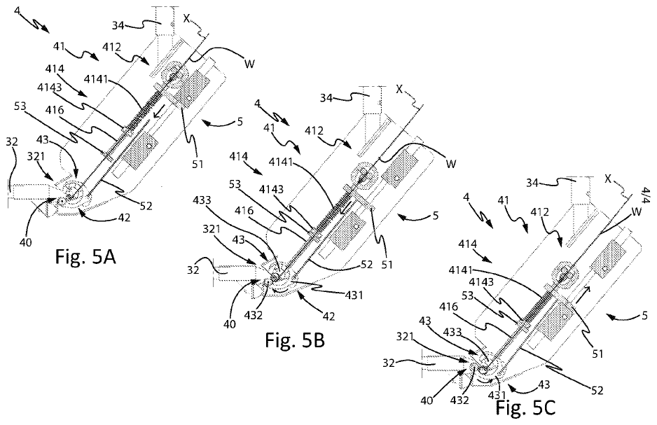

FIGS. 5A, 5B and 5C show the tying device in three different operating configurations; in particular, FIG. 5A shows the tying system in the second configuration with said tying device in the first operating configuration, since it has not been activated yet; FIG. 5B shows the tying system in the second configuration with said tying device in the second operating configuration, wherein the forming device has suitably bent the wire; FIG. 5C shows the tying system in the second configuration with said tying device in the third operating configuration, wherein the cutting device has cut the wire previously bent by said forming device, thus separating it from the rest of the wire coming from the feeding system.

With reference to the above-listed figures, reference numeral 3 designates as a whole the tying system as such; whereas reference numeral 2 designates as a whole an espalier machine as such.

Tying system 3 according to the present invention is particularly suited for application to espalier machines 2.

Tying system 3 according to the present invention comprises: a support structure 31 adapted to allow tying system 3 to be connected to an espalier machine 2; a first arm 32, suitably connected to said support structure 31, wherein said first arm 32 is adapted to assume a first configuration and a second configuration different from said first configuration; and a second arm 34, suitably connected to said support structure 31, wherein said second arm 34 is adapted to interact with said first arm 32 in said second configuration.

Tying system 3 further comprises an actuator 33. Said actuator 33 is adapted to at least move said first arm 32 between said first configuration and said second configuration.

Said first arm 32 comprises a first guide member 321, positioned at a distal end of said first arm 32 relative to said support structure 31. Said first guide member 321 is adapted to guide a first cord “C1”. Preferably, said first guide member 321 is fork-shaped.

Said second arm 34 comprises a tying device 4 positioned at a distal end of the second arm 34 relative to said support structure 31.

Said tying device 4 comprises, in turn, a second guide member 40 adapted to guide a second cord “C2”. Preferably, said second guide member 40 is U-shaped.

In general, said tying system 3 according to the present invention is adapted to arrange said first cord “C1” and said second cord “C2” side by side in said second configuration of said first arm 32.

Said tying device 4 further comprises: a feeding system 41 adapted to move a wire “W” coming from a first reel “R”; and a cutting device 42 adapted to cut said wire “W”.

Said tying device 4 further comprises a forming device 43. Said forming device 43 is adapted to suitably bend, in particular by plastic or permanent deformation, said wire “W” coming from said feeding system 41, thereby trapping said first cord “C1” and said second cord “C2” arranged side by side in said second configuration of said first arm 32, before said wire is cut by said cutting device 42.

Said cutting device 42 is adapted to cut wire “W” that has been suitably bent by said forming device 43 for trapping said first cord “C1” and said second cord “C2” arranged side by side in said second configuration of said first arm 32, thus separating said suitably bent wire “W” from the rest of wire “W” coming from said feeding system 41.

The present invention does not require the use of clips or staples, whether metal or plastic ones, pre-formed and stored into magazines, because tying system 3 according to the present invention comprises a tying device 4 that traps and mutually ties the two cords (C1, C2) by means of a wire “W”. This results in a big economical advantage for the user, since there will be no need to purchase any specific consumable material. Therefore, tying system 3 according to the present invention, and particularly said tying device 4, is so designed as to be able to bend wire “W” prior to cutting it, thus operating differently from the solutions currently known in the art.

Tying system 3 according to the present invention can therefore be applied to an existing espalier machine 2.

Tying system 3 according to the present invention, and hence espalier machine 2 whereon it is installed, is light and compact, and allows an operator to work easily and safely even on steep hilly vineyards.

In general, by means of said tying system 3 the pair of cords (C1, C2) is laid on both sides of a row of plants and, as a function of one or more variables, they are made to approach each other by arranging them side by side, and then tied with said wire “W”. Said variables may be one or more of, for example, time, distance, vegetation quantity, etc. Said variables can be detected by means of one or more sensors.

Generally, said tying system 4 comprises a protection casing that houses its systems and devices. Said tying device 4 is connected to the second arm 34 of tying system 3 through said casing.

In a preferred embodiment of tying system 3 according to the present invention, said wire “W” is a metal wire, e.g. iron wire, steel wire, galvanized wire, etc., as normally used in vineyard systems. By way of non-limiting example, said metal wire is a wire having a diameter ranging between 1 mm and 3 mm, e.g. 1.8 mm, 2.2 mm or 2.7 mm.

In a preferred embodiment, said first reel “R” is located in a position remote from tying system 3, e.g. in a position remote from espalier machine 2, e.g. on a tractor “T” to which espalier machine 2 is connected, e.g. in a rear part of tractor “T”. This solution makes it possible to position a load associated with tying system 3, and generally with espalier machine 2, in a region where it has the least effect on the stability of tying system 3 and of espalier machine 2 itself, since it can be arranged in proximity to tractor “T”, e.g. in the rear part of tractor “T”. Preferably, said cords (C1, C2) are cords commonly employed in agriculture, e. g. made of fabric, nylon and/or hemp.

In a preferred embodiment of tying system 3 according to the present invention, said actuator 33 is adapted to move also said second arm 34. In the present embodiment, said second arm 34 is also adapted to assume a first configuration and a second configuration, for the purpose of arranging said first cord “C1” and said second cord “C2” side by side in said second configuration. Preferably, said actuator 33 is adapted to move said first arm 32 and said second arm 34 synchronously. Preferably, said actuator 33 is adapted to move said first arm 32 and said second arm 34 in such a way that in said first configuration the distance between said first guide member 321, comprised in the first arm 32, and said second guide member 40, comprised in tying device 4 comprised in said second arm 34, is longest; on the contrary, in said second configuration the distance between said first guide member 321 and said second guide member 40 is shortest, so that they can interact in order to arrange said first cord “C1” and said second cord “C2” side by side.

In one possible embodiment, said actuator 33 is a single actuator.

In one possible embodiment, said actuator 33 is adapted to move said arms (32, 34) by having them make an oscillating movement about a respective axis. In an alternative embodiment, said actuator 33 is adapted to move said arms (32, 34) by having them make linear movements along an axis in both directions.

In a preferred, but merely illustrative and non-limiting, embodiment of tying system 3 according to the present invention, said feeding system 41 and said cutting device 42 are driven by a single actuator device 5. The present embodiment makes it possible to further reduce the weight of tying system 3, in that a single actuator device 5 can drive both said feeding system 41 and said cutting device 42. Moreover, by reducing the number of actuators, this embodiment makes it possible to reduce the weight of the supply circuit of said actuator device 5, in addition to simplifying the design of said supply circuit, since a smaller number of cables, pipes, ducts and/or conductors is required to ensure the proper operation of tying device 4, and more generally of tying system 3 and of entire espalier machine 2.

In a preferred embodiment of tying system 3 according to the present invention, said actuator device 5 is a pair of opposed single-acting pistons, consisting of two barrels and a single rod. The present embodiment also simplifies the supply of said actuator device 5, since only two supply ducts are necessary, in particular two ducts for the hydraulic supply of said pair of hydraulic cylinders. This embodiment is reliable and easy to implement, in addition to having a simple design.

According to an alternative embodiment (not shown), said feeding system 41 is driven by a distinct actuator device which is independent of the actuator device that drives said cutting device 42.

Describing now in more detail some possible embodiments of tying system 3 according to the present invention, in one possible embodiment of tying device 4 said feeding system 41 comprises a stopper device 412. Said stopper device 412 is adapted to allow wire “W” to move only towards said forming device 43, preventing the wire “W” from moving in the opposite direction. The present embodiment ensures that forming device 43 can be correctly fed with said wire “W”, avoiding that said wire “W” might accidentally be removed from tying system 3 or from tying device 4, thus preventing the operation of tying system 3. Stopper device 412 guarantees operational continuity of tying device 4 and, more generally, of tying system 3.

In one possible embodiment of tying system 3 according to the present invention, said feeding system 41 comprises an advancer device 414. Said advancer device 414 is adapted to move wire “W” towards said forming device 43, e. g. by causing it to advance towards said forming device 43 by a known length, i. e. a known quantity. The present embodiment ensures that said forming device 43 can operate with a known length of wire “W”, so that said first cord “C1” and said second cord “C2” arranged side by side in said second configuration of said arms (32, 34) will be certainly trapped by said suitably bent wire “W”, before said wire “W” is cut.

In one possible embodiment of tying system 3 according to the present invention, said feeding system 41 further comprises a guide member 416 adapted to guide wire “W”. The present embodiment facilitates the movement of wire “W” within tying device 4, in addition to making tying device 4, and more generally tying system 3, easier to set up by facilitating the insertion and positioning of wire “W” in feeding system 41 and in forming device 43, e.g. prior to the first use or after all wire “W” in first reel “R” has been used up.

Said guide member 416 is connected to both said advancer device 414 and said stopper device 412, moving integrally therewith. In particular, one end of said guide member 416 is connected to said stopper device 412.

In a preferred embodiment of tying system 3 according to the present invention, said forming device 43 is adapted to bend said wire “W”, causing it to assume a circular conformation, e.g. a loop-like shape, which may either be open or, preferably, closed. In particular, with a closed loop one can rest assured that said loop will not come off during the next plant processing stages, e.g. picking or harvesting, in particular when automatic machines are used.

Generally, in one possible embodiment of tying system 3 according to the present invention, said forming device 43 comprises: an inlet 430 for wire “W”; and a first mobile element 431 adapted to guide wire “W” to define a first bend of wire “W”. Preferably, said first mobile element 431 comprises a guide portion adapted to guide said wire “W” while giving it a first curvature.

Preferably, said inlet 430 and said first mobile element 431 are so positioned relative to each other that the action of wire “W” upon said first mobile element 431 is such as to avoid any sticking and to facilitate the bending of wire “w”.

Preferably, said forming device 43 further comprises a second mobile element 432. Said second mobile element 432 is preferably connected to said first mobile element 431.

Said second mobile element 432 is adapted to guide said wire “W” to define a second bend of wire “W”. The present embodiment envisages that wire “W” is subjected to a second bending action exerted by a second mobile element 432, for the purpose of avoiding any sticking of wire “W” while forming the second bend, so as to ensure that said cords (C1, C2) will be trapped correctly.

In one possible embodiment, said second mobile element 432 is a rolling element, e.g. adapted to turn idle about an axis, e.g. being a wheel or a roller, preferably a ball bearing. More particularly, wire “W” pushed by feeding system 41, which has been subjected to a first bend, in particular a curvature, by said first mobile element 431, abuts against said second mobile element 432, which, as it turns, steers it in the desired direction and bends wire “W” again, in particular by forming a second bend, in particular a second curvature.

Preferably, said first mobile element 431 and said second mobile element 432 are so positioned that wire “w”, coming from said first mobile element 431, acts upon said second mobile element 432 in such a way as to generate a continuous and uniform bend in wire “W”, so that, in particular, it will have a circular conformation, being preferably shaped as a loop, more preferably as a closed loop.

Preferably, said second mobile element 432 is fixed to said first mobile element 431 and can turn about an axis.

Said forming device 43 further comprises a fixed element 433, relative to which said first mobile element 431 moves. Preferably, said fixed element 433 defines an axis of rotation about which said first mobile element 431 can rotate, e.g. with an oscillating motion. Preferably, the axis of rotation of said first mobile element 431 is parallel to the axis of rotation of said second mobile element 432.

In one possible embodiment, said fixed element 433 defines a guide adapted to guide wire “W” to ensure that a third bend will be applied to wire “W”. The present embodiment guarantees that, if the bends made by said first mobile element 431 and said second mobile element 432 are not sufficient to trap said cords (C1, C2), fixed element 433 will provide the necessary curvature.

Preferably, said fixed element 433 is constrained to the casing of tying device 4.

More generally, said forming device 43 is adapted to bend said wire “W” into a loop, preferably a closed loop, before said wire “W” is cut by said cutting device 42.

In a preferred embodiment of tying system 3 according to the present invention, said cutting device 42 is integrated into said forming device 43. The present embodiment makes tying system 3 more compact, resulting in a smaller and lighter tying system 3 and a smaller and lighter espalier machine 2. Moreover, the present embodiment permits the use of a single actuator device 5 for driving both feeding system 41 and cutting device 42. Preferably, in fact, forming device 43 does not require an actuator to operate, because the bend in wire “W” is obtained solely due to the conformation of forming device 43 and to the thrust force generated by actuator device 5 and then transferred through feeding system 41 that pushes wire “W” towards said forming device 43.

In one possible, but merely illustrative and non-limiting, embodiment, said cutting device 42 is integrated into said first mobile element 431 of forming device 43. Preferably, the movement of said first mobile element 431 relative to said fixed element 433 causes wire “W” to be cut. In fact, wire “W” goes through said fixed element 433 and said first mobile element 431, and, as said first mobile element 431 moves, a punctual cutting force is exerted on wire “W” and cuts it.

In a preferred embodiment of tying system 3 according to the present invention, said cutting device 42 is connected to said actuator device 5 through a push-rod 52. In particular, said actuator device 5 acts upon said push-rod 52 only upon reaching a predetermined travel of said actuator device 5. The present embodiment provides a much longer total travel of actuator device 5, in particular for driving feeding system 41, and only when actuator device 5 has reached a specific travel said actuator device 5 can really actively operate said cutting device 42 in order to cut wire “W”.

In a preferred embodiment of tying system 3 according to the present invention, said actuator device 5 is connected to said feeding system 41 through a collar 51, thus allowing it to move along an axis “X”. Preferably, said actuator device acts upon said push-rod 52 through said collar 51.

More generally, said actuator device 5 allows, as it moves, tying device 4 to assume different operating configurations. In particular, it provides: a first operating configuration, or initial configuration, wherein tying device 4 is idle and awaits activation for mutually tying said cords (C1, C2); a second operating configuration, or bending configuration, wherein wire “W” is bent for trapping the cords (C1, C2); and a third configuration, or cutting configuration, wherein wire “W” is cut.

More generally, said actuator device 5 is activated to allow tying device 4 to assume the different operating configurations only when said tying system 3 has reached said second configuration of said arms (32, 34).

Describing now more in detail one possible, but merely illustrative and non-limiting, embodiment of feeding system 41, said stopper device 412, which is adapted to allow wire “W” to move only towards said forming device 43, comprises a housing structure defining two converging inclined planes. said housing structure is preferably made of metallic material. Said housing structure houses two first rollers, preferably made of metal, which are adapted to slide on a respective inclined plane. Said housing structure also houses a second roller, preferably made of plastic material such as Teflon, which is adapted to act upon said first rollers under the action of an elastic member, e.g. a coil spring, so that said first rollers will act upon both wire “W” and the respective inclined planes. Said first rollers are, therefore, positioned on inclined planes to retain wire “W” in order to prevent said wire “W” from moving in the direction opposite to the direction of movement towards said forming device 43. By means of a purely mechanical device with no actuators, the present embodiment permits wire “W” to move solely in the desired direction, preventing wire “W” to move in the opposite direction along an axis “X”.

In one possible, but merely illustrative and non-limiting, embodiment of advancer device 414, it comprises an elastic member 4141, in particular a coil spring, one end of which abuts on said collar 51, connected to actuator device 5, while the other end abuts on a stopper element 4143, to which said guide element 416 is also connected, which protrudes from said stopper element 4143 towards said forming device 43.

Said guide member 416 passes through said collar 51 and, at its opposite end, is connected to said stopper device 412, e.g. to said housing structure.

The movement of actuator device 5 along an axis parallel to said axis “X”, in particular for switching from said first configuration to said second configuration, causes said collar 51, which moves integrally with said actuator device 5, to drive said advancer device 414. The movement of advancer device 414 results in a displacement of guide member 416 and of stopper device 412.

More generally, said collar 51 acts upon said advancer device 414, thus causing said advancer device 414, said stopper device 412 and said guide member 416 to move integrally, in particular when switching between said first configuration and said second configuration.

The travel of advancer device 414 is delimited by an end-of-travel element 53, against which said stopper element 4143 abuts. Preferably, said end-of-travel element 53 comprises a through hole allowing the passage of said guide member 416. Preferably, said end-of-travel element 53 is constrained to the casing of tying device 4.

Since said collar 51 acts upon elastic member 4141, which at its opposite end acts upon stopper element 4143 to which said guide member 416 is fixed, to the end of which said stopper element 412 is fixed, the movement of actuator device 5 along its travel, in particular when switching from said first configuration to said second configuration, will pull wire “W” towards said forming device 43, while preventing wire “W” from moving in the opposite direction.

The travel of said advancer device 414 up to said end-of-travel element 53 is such as to ensure that wire “w” will be suitable bent by forming device 43, so that it will trap cords (C1, C2). Preferably, the travel of actuator device 5, sufficient to ensure that wire “W” will be suitably bent by forming device 43, is at least 5 cm, preferably at least 7 cm. Preferably, the travel of said actuator device 5 is sufficient to create a loop, preferably a closed loop, of wire “W”, in particular, for switching from said first configuration to said second configuration. The present embodiment makes it possible to form open or closed loops having a diameter smaller than or equal to 2.5 cm, which is sufficient to trap said two cords (C1, C2).

In the preferred embodiment of tying device 4, when a predetermined travel of actuator device 5 has been reached, e.g. corresponding to said second configuration, forming device 43 has suitably bent said wire “W”, thereby trapping said cords (C1, C2). A further travel of actuator device 5 triggers the activation of cutting device 42; in particular, such further travel causes actuator device 5 to act upon said push-rod 52 to activate said cutting device 42, in particular by turning said first mobile element 431 of forming device 43, in which said cutting device 42 is integrated. Preferably, said further travel is about 1.5 cm. In particular, said further travel allows tying device 4 to switch from the second configuration to said third configuration.

During said further travel of actuator device 5, elastic member 4141, after abutting on said end-of-travel element 53 through said stopper element 4143 under the thrust of actuator device 5, is compressed by said collar 51. This situation provides better control over the travel of actuator device 5, since an additional elastic force needs to be overcome to allow the movement of actuator device 5.

The compression of said elastic member 4141 results in said stopper device 412 and said guide member 416 not being moved, and wire “W” not being pushed any further towards forming device 43, thereby holding wire “W” in position so that cutting device 42 can work properly.

Once actuator device 5 has completed said further travel and cutting device 42 has cut wire “W”, in particular reaching said third configuration, said actuator device 5 is activated to run through its travel in the opposite direction, in order to return into said first configuration or initial configuration. At this stage, the kinetic energy released by elastic member 4141 as it extends again following compression, will facilitate the return into said first operating configuration or initial configuration.

Preferably, said cutting device 42 comprises a returning member (not shown) . Said returning member is adapted to return said first mobile element 431 into its original position after the action exerted by actuator device 5 through said push-rod 52. Said returning member is, for example, a spring.

FIGS. 2A and 2B show tying system 3 in its two different operating configurations. In particular, FIG. 2A shows tying system 3 in a first configuration, or open configuration. In this figure, one can see that arms (32, 34) connected to said support structure 31 are suitably constrained to each other so that, by means of a single actuator 33, said arms (32, 34) can move synchronously between the different configurations. FIG. 2A shows that guide members (321, 40) and arms (32, 34) are at their maximum mutual distance. Said first arm 32 comprises, at its distal end, the first guide member 321, which is fork-shaped.

Said second arm 34 comprises said tying device 4, which in turn comprises a feeding system 41, a cutting device 42 and a forming device 43.

At the distal end of tying device 4 there is the second guide member 40, which is U-shaped.

Said feeding system 41 and said cutting device 42 are driven by a single actuator device 5, which allows feeding system 41 to move wire “W” along an axis “X” towards said forming device 43.

FIG. 2B shows, on the other hand, tying system 3 in a second configuration, or closed configuration. As is visible in the drawing, actuator 33 has moved arms (32, 34), which have reached their minimum mutual distance. In this configuration, the cords guided by respective guide members (321, 40) have been arranged side by side near said tying device 4. Through said forming device 43, said tying device 4 can bend a wire “W” in such a way as to trap the cords. Once said wire “W” has been bent, cutting device 42 cuts wire “W” from the remaining part of wire “W”. In order to allow forming device 43 to bend wire “W”, the latter is moved by feeding system 41 towards said forming device 43 by making a movement along said axis “X”. Said cutting device 42 and said feeding system 41 are driven by said actuator device 5.

FIG. 3 show a tying device 4 applied to the second arm 34 in the second configuration of tying system 3, wherein wire “W” has been bent, but not yet cut.

In this figure one can also see other details of tying device 4 fixed to the distal end of second arm 34 of tying system 3. In particular, FIG. 3 shows a wire “W” positioned along an axis “X”, which passes through a stopper device 412 of feeding system 41. FIG. 3 shows stopper device 412 connected to guide member 416.

Said actuator device 5 acts upon feeding system 41 through a collar 51. In particular, said collar 51 abuts against one end of elastic member 4141, consisting of a coil spring, of advancer device 414. The opposite end of elastic member 4141 acts upon a stopper element 4143, which is connected to said guide member 416.

In FIG. 3 it is possible to see that said stopper element 4143 is in abutment with end-of-travel element 53, through which said guide member 416 can pass. Also said collar permits the passage of said guide member 416.

FIG. 3 shows tying device 4 in the second configuration, wherein wire “W” has already been bent into a closed loop by forming device 43, but wire “W” has not yet been cut by cutting device 42 to separate loop of wire “W” from remaining wire “W”. In FIG. 3 one can see that, in said second configuration, collar 51 connected to actuator device 5 is in abutment with push-rod 52, which will then allow actuator device 5 to operate cutting device 42 in order to cut wire “W” and separate looped wire “w” from the remaining part of said wire “W”.

In FIG. 3 one can see that, in fact, forming device 43 has already suitably bent wire “W”, causing it to assume a closed loop shape to trap the cords arranged side by side by guide members (321, 40) of both arms (32, 34).

FIG. 4 shows a detail of forming device 43 and cutting device 42 comprised in tying device 4 of a tying system 3 according to the present invention. In FIG. 4, first arm 32 and second arm 34 are in the second configuration, wherein two cords (C1, have been arranged side by side by respective guide members (321, 40). In this detail view, FIG. 4 shows tying device 4 in the second configuration, wherein wire “W” has already been suitably bent into a closed loop by forming device 43, but cutting device 42 has not yet been activated by actuator device 5 by means of said push-rod 52 in order to cut said wire “W”.

In the embodiment illustrated in FIG. 4, forming device 43 comprises an inlet 430, through which wire “W” enters, goes through fixed element 433, and then enters said first mobile element 431, which is adapted to form a first bend, in particular a first curvature, in wire “W”. Subsequently, wire “W” comes in abutment with second mobile element 432, which is connected, while being able to turn freely, to said first mobile element 431. Said second mobile element 432 is adapted to form a second bend, in particular a second curvature, in wire “W”. In particular, the curvature given by said second mobile element 432 to wire “W” is such as to create the looped structure shown in FIG. 4.

Said first mobile element 431 rotates about said fixed element 433, in particular with an oscillating motion.

Said cutting device 42 is integrated into forming device 43, in particular into said first mobile element 431. Said actuator device 5 moves said first mobile element 431 by means of said push-rod 52 and activates cutting device 42 to cut wire “W”.

Lastly, FIGS. 5A, 5B and 5C show tying device 4 in three different operating configurations. In particular, FIG. 5A shows tying system 3 in the second configuration, with said tying device 4 in the first operating configuration, i.e. not yet activated.

FIG. 5A shows wire “W” arranged along an axis “X” passing through a stopper device 412 of feeding system 41. FIG. 5A shows stopper device 412 connected to guide member 416. Said actuator device acts upon advancer device 414 through a collar 51. In particular, said collar 51 abuts against one end of elastic member 4141, consisting of a coil spring, of advancer device 414. The opposite end of coil spring 4141 acts upon a stopper element 4143, which is connected to said guide member 416.

In FIG. 5A, said stopper element 4143 has not yet come in abutment with end-of-travel element 53. FIG. 5A shows tying device 4 in the first configuration, wherein wire “W” has not yet been bent by forming device 43, since the end of wire “W” is at said forming device. In FIG. 5A one can see that in said second configuration collar 51 connected to actuator device 5 has not yet come in abutment with push-rod 52 that will allow actuator device 5 to operate cutting device 42 in order to cut wire “W” after the latter has been suitably bent.

FIG. 5B shows tying system 3 in the second configuration, with said tying device 4 in the second operating configuration, wherein forming device 43 has suitably bent wire “W”. By comparing FIG. 5B with FIG. 5A, one can see that actuator device 5 has been activated, causing said collar 51 to move by a predetermined travel. During such travel, stopper device 412 has stopped wire “W”, thus only allowing wire “W” to move towards said forming device 43 and preventing said wire “W” from moving in the opposite direction along said axis “X”.

Advancer device 414 allows wire “W” to slide towards forming device 43. As visible in FIG. 5B, the collar 51 is acting upon one end of coil spring 4141 of advancer device 414, while the opposite end of the same coil spring 4141 is acting upon stopper element 4143, to which said guide member 416 is connected. In FIG. 5B, stopper element 4143 is abutting on the end-of-travel element 53, which permits the passage of said guide member 416. FIG. 5B shows forming device 43, in which wire “W” has already been bent into a closed loop, but such wire “W” has not yet been cut by cutting device 42 to separate the loop of wire “W” from the remaining part of wire “W”. In FIG. 5B one can see that in said second configuration collar 51 connected to actuator device 5 is in abutment with push-rod 52 that will allow actuator device 5 to operate cutting device 42 in order to cut wire “W”.

FIG. 5C shows tying system 3 in the second configuration, with said tying device 4 in the third operating configuration, wherein cutting device 42 has cut wire “W” that was suitably bent by said forming device 43, thus separating it from the rest of wire “W” coming from said feeding system 41.

By comparing FIG. 5C with FIGS. 5A and 5B, it is possible to see that actuator device 5 has been further activated, causing collar 51 to travel further on. This further travel has caused coil spring 4141 of advancer device 414 to be compressed, while however holding in position said guide member 416 and said stopper device 412, thus preventing wire “W” from being pushed towards forming device 43. In fact, said stopper element 4143 is abutting on end-of-travel element 53, thus preventing any further forward movement.

Moreover, the action of said collar 51 upon push-rod 52 has caused said first mobile element 431 to rotate relative to said fixed element 433, thereby actuating said cutting device 42 integrated into forming device 43. The movement of said first mobile element 431 relative to said fixed element 433 was such as to cut wire “W”. Thus, the separated loop of wire “W” can retain trapped cords (C1, (2). In fact, wire “W”, already bent into a closed loop by forming device 43, is cut by cutting device 42 in order to separate the loop of wire “W” from the remaining part of wire “W”.

In order to allow such movement for cutting wire “W”, said actuator device 5 must move by an additional travel, thus reaching said third configuration.

In said third configuration, for the purpose of returning tying device 4 into the first configuration, actuator device 5 is supplied in order to move the other piston by the sum of the two previously specified travels.

Tying system 3 according to the present invention is particularly suited to be included in an espalier machine 2, the latter being adapted to raise and tie sprouts of vegetable plants, such as green vine shoots.

Said espalier machine 2 comprises: a frame 22 and fastening elements 23, connected to said frame 22, adapted to allow for a removable connection of espalier machine 2 to a tractor “T”. Preferably, said fastening elements 23 are designed to be connected in the rear part of tractor “T”, in particular to the three-point connection system comprised in tractor “T”. The present embodiment permits an easy adaptation of espalier machine 2 according to the present invention to both wheeled and tracked tractors “T”. In fact, the rear three-point connection systems of tractors is a standard one, so that it will not be necessary to apply any brackets or flanges to the structure of tractor “T” or to use any special fastening elements or applications to be able to fasten espalier machine 2 to tractor “T”. The present embodiment permits coupling and decoupling espalier machine 2 quickly to/from all types of tractors “T”. Moreover, the rear three-point connection system of a tractor “T” is specially designed to withstand high loads, and is therefore very strong and reliable.

Preferably, said frame 22 is designed to be positioned over a row of vegetable plants, preferably on both sides of a row, in particular a vineyard row.

Said espalier machine 2 according to the present invention further comprises a plurality of actuators 24. Said actuators 24 are adapted to move the parts of espalier machine 2 in order to adjust at least one position thereof relative to a row of vegetable plants.

Said espalier machine 2 according to the present invention comprises at least one raising system 25 adapted to raise sprouts of vegetable plants, in particular vine shoots. Preferably, two raising systems 25 are comprised on respective sides of the row.

Espalier machine 2 according to the present invention further comprises a tying system 3 according to the present invention, adapted to tie sprouts of vegetable plants raised by said at least one raising system 25, by laying a first cord “C1” and a second cord “C2” and tying them together by means of a wire “W” at intervals defined by one or more variables, e.g. at regular intervals, predetermined and/or defined as a function of external variables such as, for example, the identification of the most appropriate locations where cords (C1, C2) should be tied, e.g. points with less vegetation. Said cords (C1, C2) are cords like those commonly used in agriculture, e.g. made of fabric, nylon and/or hemp.

Espalier machine 2 according to the present invention comprises a first reel “R”, whereon said wire “W” is wound. Preferably, said first reel “R” is located in a position remote from said tying system 3, e.g. in proximity to tractor “T”, e.g. on that portion of frame 22 which is closest to fastening elements 23. The present embodiment makes it possible to position a load associated with tying system 3, and more generally with espalier machine 2, in a region where it will not affect the stability of tying system 3 and espalier machine 2, being positioned in proximity to fastening elements 23. Such a solution makes it possible to position the load associated with said first reel “R” in a region of tractor “T” specially designed to withstand high loads.

Espalier machine 2 according to the present invention comprises second reels “S”, whereon said first cord “C1” and said second cord “C2” are wound. Preferably, said second reels “S” are located in a position remote from said tying system 3, e.g. in proximity to tractor “T”, e.g. on that portion of frame 2 which is closest to fastening elements 23. The present embodiment makes it possible to position the load associated with such second reels “S” in a region where it will not affect the stability of tying system 3 and espalier machine 2, being positioned in proximity to fastening elements 23, in particular in a region of tractor “T” specially designed to withstand high loads.

In one possible embodiment, said raising system 25 comprises a sliding belt, preferably made of rubber, comprising protrusions or fingers that can delicately raise the vegetation, in particular said shoots. Said raising systems 25 are advantageously located in a front portion of espalier machine 2, in particular in front of tying system 3 according to the present invention, with reference to the direction of motion of the assembly consisting of espalier machine 2 and tractor “T”.

In a preferred embodiment of espalier machine 2, said fastening elements 23 are adapted to be connected to a tractor “T” at a three-point connection system available in the rear part of said tractor “T”. In the present embodiment, frame 22 comprises an upright 220 that allows said frame 22 to position itself over a row of plants, in front of said tractor “T”. Said upright 220 allows frame 22 to go over a cabin or driver seat of tractor “T” to reach the front part of tractor “T”, so that espalier machine 2 can be positioned over a row of plants. The present embodiment makes it possible to build a compact espalier machine 2 which can also be used on steep ground, e.g. on a hill, and even with short distances between rows. Furthermore, the present embodiment can be used on both wheeled and tracked tractors “T”. Since the present embodiment is connected, by means of said fastening elements 23, to the three-point connection system available in the rear part of tractor “T”, no brackets or flanges are necessary to adapt tractor “T” to the agricultural machine. Moreover, the present embodiment allows for quick coupling and release of espalier machine 2 to/from tractor “T”. Lastly, the present embodiment increases the stability of the assembly consisting of espalier machine 2 and tractor “T”, hence improving operator safety.

In one possible embodiment of said espalier machine 2, as it moves forwards along a row of plants, frame 22 is positioned across the row and its position can be adjusted by means of actuators 24.

In one possible embodiment, said espalier machine 2 comprises two raising systems 25, wherein each raising system 25 comprises a sliding belt provided with protrusions for raising the hanging shoots of the plant. Each one of said raising systems 25 is placed on one side of the row of plants, in order to raise the shoots on both sides of the row of plants.

Through said tying system 3, the pair of cords (C1, C2) are laid on both sides of the row of plants and, as a function of one or more variables, such cords are arranged side by side and then tied by means of said wire “W”. In a preferred embodiment, said arms (32, 34) are made to switch from the first configuration to the second configuration by actuator 33, so that said arms (32, 34) of tying system 3 will approach each other. In particular, the first cord “C1”, guided by the first guide member 321 of the first arm 32, is made to approach the second cord “C2”, guided by the second guide member 40 comprised in tying device 4 comprised in said second arm 34. In particular, said first arm 32 and said second arm 34 are arranged on both sides of the row of plants and move relative to each other with an oscillating motion, switching from said first configuration to said second configuration.

When said arms (32, 34) are in the second configuration, tying device 4 is activated in order to mutually tie said cords by means of a wire “W”. In particular, said forming device 43 is adapted to bend said wire “W”, preferably generating a loop of wire “W”, in order to tie said cords (C1, C2) together.

In a preferred embodiment of tying device 4, it comprises a single actuator device 5, in the form of two opposed single-acting pistons, consisting of two barrels and a single rod, wherein the latter slides along a travel calibrated to allow said forming device 43 to bend said wire “W”, for the purpose of trapping said cords (C1, C2), in particular by forming a loop of wire “W”, and then cut said wire “w” by means of said cutting device 42. In particular, a travel of approximately 7 cm is required in order to bend said wire “W”, whereas a further travel of approximately 1.5 cm is required in order to cut said bent wire “W”.

Said feeding system 41 comprises a stopper device 412, which is movable under the action of said actuator device 5.

Said feeding system 41 further comprises an advancer device 414, which comprises an elastic member 4141 in the form of a coil spring, which slides as actuator device 5 moves, wherein said spring is adapted to act, at one end thereof, upon a collar 51, connected to said actuator device 5, and, at the other end thereof, upon said stopper element 4143. More particularly, starting from said first configuration, actuator device 5 drives said feeding system 41 until said stopper element 4143 comes in abutment with end-of-travel element 53. During such travel, said forming device 43 can bend such moved wire “W”, preferably into a loop. When said stopper element 4143 comes in abutment with end-of-travel element 53, wire “W” is no longer made to advance by said advancer device 414. At the same time, collar 51 comes in abutment with push-rod 52 connected to cutting device 42. As it continues its travel, actuator device 5 causes elastic member 4141 to be compressed, thus ensuring that wire “W” cannot be pushed any further towards forming device 43, and at the same time the motion imparted to push-rod 52 causes the activation of cutting device 42, in particular by rotating said first mobile element 431, which, as it turns relative to said fixed element 433, cuts wire “W” and separates the portion of wire “W” that was previously bent, e.g. into a closed loop, from the remaining part of wire “W”. Combined with the moving first mobile element 431, said fixed element 433 constrained to said casing cuts wire “W” after it has been bent, in particular after a loop has been created.

As it runs through stopper device 412 and advancer device 414 to reach forming device 43, wire “W” is guided by said guide member 416, e. g. provided in the form of a wire-carrying tube. Said guide member 416 can slide freely through said end-of-travel element 53.

In one possible embodiment of tying system 3, the following operations are carried out in order to switch from said first configuration of tying device 4 to said third configuration of tying device 4. When switching from the first configuration to the second configuration of tying device 4, actuator device 5, in the form of a pair of opposed single-acting hydraulic pistons, is supplied in order that actuator device 5 will push, through said collar 51, advancer device 414, and particularly elastic member 4141, until said stopper element 4143 comes in contact with said end-of-travel element 53. This travel of actuator device 5 is, for example, 7 cm. This movement results in an equal movement of wire “W”, which will then be bent by forming device 43 to create said loop and trap said cords (C1, C2). At the end of this travel, tying device 4 is in said second configuration, wherein the loop of wire “W” has been formed, but wire “W” has not been cut yet. At the end of such travel of actuator device 5, collar 51 meets push-rod 52, which is adapted to operate said cutting device 42. As it continues to move, actuator device 5 compresses said elastic member 4141 of advancer device 414, thereby preventing wire “W” from being pushed any further towards forming device 43; at the same time, the action of said collar 51 upon push-rod 52 causes said first mobile element 431 to rotate relative to said fixed element 433, thereby actuating said cutting device 42 integrated into forming device 43.

The movement of said first mobile element 431 relative to said fixed element 433 is such as to cut wire “W”. Thus, the loop of wire “W” has been separated and can retain said trapped cords (C1, C2).

In order to allow such movement for cutting wire “W”, said actuator device 5 must, starting from said second configuration, travel a further distance to reach said third configuration. When tying device 4 is in said third configuration 4, actuator device 5 is supplied in order to move the other piston and return into said first configuration.

FIG. 1 shows a rear axonometric view of an espalier machine 2 applied to a tractor “T”. In FIG. 1, espalier machine 2 is connected, by means of fastening elements 23, to the rear of the tractor, where a three-point connection system is available, which is not shown in the drawings but well-known to those skilled in the art.

Frame 22 of espalier machine 2 extends from said fastening elements 23 through an upright 220 that allows frame 22 to go over the cabin or driver seat of tractor “T” to reach the front part of said tractor “T”.

Said espalier machine 2, and particularly frame 22, is shaped as a portal, so that the machine can operate over a row of plants. FIG. 1 shows a plurality of actuators 2 that make it possible to adjust the position of espalier machine 2 relative to the row of plants.

Two mutually facing raising systems 25 are connected to said frame 22. Said raising systems 25 are provided as sliding belts fitted with protrusions for raising the shoots on both sides of the row of plants. Said raising systems 25 are located in the front part of the espalier machine 2.

Said tying system 3 is arranged behind said raising systems 25. Said tying system 3 comprises: a support structure 31 connected to frame 22 of espalier machine 2. Tying system 3 comprises a first arm 32 and a second arm 34 connected to said support structure 31. In FIG. 1, said arms (32, 34) are in the second configuration, wherein there is a minimal distance between them and they can interact with each other. Tying system 3 comprises an actuator 33 adapted to move said arms (32, 34) between said first configuration and said second configuration with an oscillating motion.

Said second arm 34 comprises a tying device 4 located at a distal end of the second arm 34. Tying system 3 is adapted to arrange a first cord “C1” and a second cord “C2” side by side in said second configuration of arms (32, 34), and to tie them together by means of a wire “W” suitably bent by said tying device 4.

Each one of said cords (C1, C2) is wound on a second reel “S”. Said second reels “S”, as shown in FIG. 1, are located in a position remote from said tying system 3, e.g. in proximity to fastening elements 23 adapted to be connected to tractor “T”.

Said wire “W” is wound on a first reel “R”, which is also arranged in a position remote from said tying system 3, e.g. in proximity to fastening elements 23 adapted to be connected to tractor “T”. In FIG. 1 said reels (R, S) are arranged close to one another, e. g. enclosed in a suitable protection casing, which is shown to be partially open in FIG. 1. FIG. 1 also shows, at least partly, the paths followed by cords (C1, C2) and by wire “W” to arrive at said tying system 3.

More generally, tying system 3 according to the present invention permits the use of a coil of wire “W”, wound on the first reel “R”, which can be conveniently positioned in the rear part of tractor “T”.

Tying device 4 according to the present invention makes it possible to form loops, in particular closed loops, of wire “W” for trapping both cords (C1, C2), and to subsequently cut said bent wire “W” to separate it from the rest of wire “W”.

Tying system 3 according to the present invention permits tying cords (C1, C2) at intervals, defined by one or more variables, when said arms (32, 34) are in said second configuration.

Tying system 3 according to the present invention does not require the use of clips or staples because tying device 4 alone can suitably bend wire “W” into closed loops. In fact, tying device 4 simply makes use of wire “W”, e. g. normal metal wire, galvanized wire, etc., as traditionally used in vineyard systems.

The present invention offers the user a considerable economical advantage, because there will be no need to purchase any specific consumable material.

Tying system 3 and espalier machine 2 are light and compact, and allow an operator to work easily and safely even on steep hilly vineyards.

Any alternative embodiments of tying system 3 and espalier machine 2 which have not been expressly described herein, but which can be easily inferred by a person skilled in the art in the light of the technical contents of the present patent application, shall be considered to fall within the protection scope of the present patent application.

### REFERENCE NUMERALS

Espalier machine 2
Frame 22
Upright 220
Fastening elements 23
Actuators 24
Raising system 25
Tying system 3
Support structure 31
First arm 32
First guide member 321
Actuator 33
Second arm 34
Tying device 4
Second guide member 40
Feeding system 41
Stopper device 412
Advancer device 414
Elastic member 4141
Stopper element 4143
Guide member 416
Cutting device 42
Forming device 43
Inlet 430
First mobile element 431
Second mobile element 432
Fixed element 433
Actuator device 5
Collar 51
Push-rod 52
End-of-travel element 53
First cord “C1”
Second cord “C2”
First reel “R”
Second reels “S”
Tractor “T”
Wire “W”
Axis “X”

1. Tying system for espalier machines, comprising:
a support structure adapted to allow the tying system to be connected to an espalier machine;
a first arm connected to said support structure adapted to assume a first configuration and a second configuration different from said first configuration;
a second arm connected to said support structure adapted to interact with said first arm in said second configuration;
an actuator adapted to at least move said first arm between said first configuration and said second configuration;
said first arm comprising a first guide member, positioned at a distal end of said first arm relative to said support structure, wherein said first guide member is adapted to guide a first cord;
said second arm comprising a tying device positioned at a distal end of the second arm relative to said support structure;
said tying device comprising a second guide member adapted to guide a second cord;
said tying system being adapted to arrange said first cord and said second cord side by side in said second configuration of said first arm;
said tying device comprising:
a feeding system adapted to move a wire coming from a first reel;
a cutting device adapted to cut said wire;
a forming device adapted to bend said wire coming from said feeding system, thereby trapping said first cord and said second cord arranged side by side in said second configuration of said first arm, before said wire is cut by said cutting device;
said cutting device being adapted to cut the wire that has been bent by said forming device for trapping said first cord and said second cord arranged side by side in said second configuration of said first arm, thus separating said bent wire from the rest of the wire coming from said feeding system.

2. Tying system according to claim 1, wherein said actuator is adapted to move said second arm, said second arm being adapted to assume a first configuration and a second configuration to arrange said first cord and said second cord side by side in said second configuration.

3. Tying system according to claim 1, said feeding system and said cutting device being driven by a single actuator device.

4. Tying system according to one of claim 1, wherein said feeding system comprises:
a stopper device adapted to allow the wire to move only towards said forming device, preventing the wire from moving in an opposite direction;
an advancer device adapted to move the wire towards said forming device;
a guide member adapted to guide the wire

5. Tying system according to claim 1, said forming device comprising:
an inlet for the wire;
a first mobile element adapted to guide the wire to define a first bend of the wire;
a second mobile element, connected to said first mobile element, adapted to guide said wire to define a second bend of the wire;
a fixed element, wherein said first mobile element moves relative to said fixed element.

6. Tying system according to claim 1, wherein said cutting device is integrated into said forming device.

7. Tying system according to claim 5, wherein said cutting device is integrated into said first mobile element of the forming device.

8. Tying system according to claim 3, wherein said actuator device comprises a pair of opposed single-acting pistons, including two barrels and a single rod.

9. Tying system according to claim 3, wherein said actuator device is connected to said feeding system through a collar, allowing the actuator device to move along an axis;
said cutting device is connected to said actuator device through a push-rod.

10. Espalier machine for raising and tying sprouts of vegetable plants, comprising:
a frame;
fastening elements connected to said frame, adapted for removably connecting the espalier machine to a tractor;
a plurality of actuators adapted to move parts of the espalier machine to adjust at least one position of the espalier machine relative to a row of vegetable plants;
at least one raising system, adapted to raise the sprouts of the vegetable plants;
a tying system adapted to tie the sprouts of the vegetable plants raised by the raising system, by laying a first cord and a second cord and tying the first cord and the second cord together by a wire at intervals defined by one or more variables;
a first reel whereon said wire is wound;
second reels whereon said first cord and said second cord are wound;
said tying system comprising the tying system according to claim 1.

11. Espalier machine according to claim 10, wherein said fastening elements are adapted to be connected to a tractor at a three-point connection system located in a rear part of said tractor.

12. Espalier machine according to claim 11, wherein said frame (22) comprises an upright that allows said frame to be positioned over a row of plants, in front of said tractor.

13. Espalier machine according to claim 11, wherein said first reel is located in a position which is remote from said tying system and proximate to a portion of the frame which stands in proximity to the fastening elements.
